(19) United States
(12) Patent Application Publication
(10) Pub. No.: US 2006/0136815 A1
(43) Pub. Date: Jun. 22, 2006

(54) Apparatus and method for reproducing content and information storage medium therefor

(75) Inventors: Kil-soo Jung, Gyeonggi-do (KR); Hyun-kwon Chung, Seoul (KR); Sung-wook Park, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/352,272

(22) Filed: Feb. 13, 2006

Related U.S. Application Data
(63) Continuation of application No. 10/626,716, filed on Jul. 25, 2003.

(30) Foreign Application Priority Data
Jul. 27, 2002 (KR) 2002-44505
Oct. 1, 2002 (KR) 2002-59777
Jun. 27, 2003 (KR) 2003-42792

(51) Int. Cl. G06F 17/21

(52) U.S. Cl. 715/513

(57) ABSTRACT

A content reproducing apparatus and method in which transferring of information and/or sharing system parameters between markup documents are enabled without heavily loading a central processing unit, and there is no need to define a new browser, and an information storage medium having a computer program therefor. The content reproducing apparatus includes a data storage unit storing and/or reading data and a presentation engine controlling the data storage unit according to a command program contained in an input markup document.

### CROSS-REFERENCE TO RELATED APPLICATIONS

This application is a continuation of U.S. patent application Ser. No. 10/626,716, filed Jul. 25, 2003, currently pending, which claims the priority of Korean Patent Application No. 2002-44505 filed on Jul. 27, 2002, Korean Patent Application No. 2002-59777 filed on Oct. 1, 2002, and Korean Patent Application No. 2003-42792 filed on Jun. 27, 2003, in the Korean Intellectual Property Office, the disclosures of which are incorporated herein in their entirety by reference.

### BACKGROUND OF THE INVENTION

1. Field of the Invention

The present invention relates to an apparatus and method to reproduce content and an information storage medium therefor, and more particularly, to a content reproducing apparatus and method by which transferring information and sharing system parameters related to audio/video reproduction between markup documents are enabled in a reproducing apparatus to reproduce content produced by using a markup language, and an information storage medium therefor.

2. Description of the Related Art

Interactive contents refer to data stored in an information storage medium, for example, an interactive digital versatile disc (DVD), in which audio/video (AV) data and a markup document to support an interactive function are stored together. The markup document is a document written in a markup language such as a hyper text markup language (HTML) or an extended markup language (XML).

The AV data recorded on an interactive DVD may be reproduced in the same manner as the AV data recorded on an ordinary DVD-video, or an AV screen. The AV data may be reproduced and displayed through a browser, and may be embedded in a display window defined in the markup document and displayed with the markup document. In the latter case, an interactive function is supported. For example, when the AV data is a movie title, the interactive function is shown as a variety of interactive contents in which a movie is being shown on a part of the display window, a caption is displayed on another part of the display window, and a still picture advertising a trailer is put on still another part.

Meanwhile, the markup document includes a script tag written in a script language in order to implement a simple function that cannot be expressed by the markup language. A script is a program or a list of instructions that are interpreted or executed by other programs. Among the script languages, there are Perl, Java Script, and REXX, which are used by an IBM mainframe. The Java script contained in a web page is executed by a web browser, that is, by a client side. In general, the script languages are more structured, and can be used more easily and quickly than such languages as C and C++, which need compiling. Accordingly, the script languages are appropriate for generating a program having a very limited capability, or programs that can be reused after being connected to an already compiled program.

However, because information generated in the markup document containing the script is erased when the markup document is changed by another markup document, the information cannot be transferred between markup documents. When discs are changed because a content thereof is written in a plurality of discs, the same problem occurs such that the information cannot be transferred between the markup documents stored in different discs. To solve this problem, first, a new browser (viewer) that memorizes all information even when the markup document is changed by another markup document may be defined, or, secondly, an external program, such as a Java application, may be used so that the information can be stored even when the markup document displayed by the browser is changed. However, the former method in which the new browser is defined is inefficient in time, cost, and efforts. Also, the latter method, in which the external program, such as the Java application, is written and used, demands millions of instructions per second (MIPS) power of a central processing unit (CPU) in the reproducing apparatus, where the computational burden is too heavy for a home-use reproducing apparatus whose system resources are limited.

Meanwhile, in a web environment, a cookie is used for storing and exchanging the information between a client and a server. The cookie is special text data which the web page inserts to the local storage, for example, a hard disc, of a client. Because the cookie is a stateless protocol in which a hyper text transfer protocol (HTTP), which is a web protocol, does not memorize what happened before, the web server does not have any records of a page (markup document) that was transmitted to the user, and it is difficult to know even whether or not the user previously visited the web page. The cookie is usually stored in a lower layer of a browser directory used by the user, for example, in a sub directory of a Netscape directory. All cookies on web pages that the user visited are stored in a cookie directory.

A process for exchanging information between the client and the server using the cookie will now be explained briefly.

First, the server selected by an HTTP request from the client provides access to a requested resource as an HTTP response. The HTTP response containing a SET_COOKIE command, which commands the cookie in the header of the response to be stored in the local data storage apparatus of the client, is transmitted to the client together with the requested markup document. The SET_COOKIE command is generated when the user requests the data for the first time from a predetermined server through the browser. Information stored by the cookie may include, for example, the domain address of a uniform resource identifier (URI) for which the cookie can be used effectively, the directory of an URI for which the cookie can be used effectively, a name and a value of the cookie, and date when the cookie ends.

The client parses and renders the markup document file transmitted by the server.

The client stores information in the HTTP header in the local storage according to a function defined in the markup document.

When the client accesses the server again, the client confirms the domain and route of the server input by the user, accesses the cookie information corresponding to the server stored in the local storage of the client, adds the cookie information to the HTTP header, and transmits the cookie information to the server. Accordingly, information is exchanged between the server and the client.

### SUMMARY OF THE INVENTION

According to an aspect of the present invention, there is provided an apparatus and method to reproduce contents, where predetermined information on a current markup document is stored using a cookie. Further, in the reproducing apparatus and method needed information is read by referring to the stored cookie so that transferring of the information and sharing system parameters related to AV data reproduction between different markup documents are enabled. According to an aspect of the present invention, there is provided an information storage medium for the apparatus and the method.

According to an aspect of the present invention, there is provided a content reproducing apparatus including a data storage unit storing and/or reading data; and a presentation engine controlling the data storage unit according to a command program contained in an input markup document.

The presentation engine includes a parser verifying a syntax of the markup document; a document object model (DOM) tree forming unit receiving the markup document from the parser, interpreting a structure of the markup document, and extracting the command program; and an interpreter receiving the extracted command program from the DOM tree forming unit to control the data storage unit.

The command program may include at least one of a cookie generation command program which commands generation of cookie information, a cookie reference command program which commands a search for at least one cookie information item stored in a data storage unit and fetch of a value of predetermined target information, and a cookie deletion command program which commands a search for at least one cookie information item stored in a data storage unit and deletion of predetermined cookie information.

The presentation engine may incorporate identification information on content related to the markup document into the cookie information and store the cookie information in the data storage unit.

According to another aspect of the present invention, there is provided a content reproducing method including receiving a markup document comprising a predetermined command program; parsing to verify a syntax of the markup document; extracting the command program by interpreting a structure of the markup document; and controlling a data storage unit according to the command program.

In the method, the command program may include a cookie generation command program, and may include according to the cookie generation command program, generating cookie information comprising predetermined target information; and storing the generated cookie information in the data storage unit.

The generation of the cookie information may include incorporating identification information on content related to the markup document into the cookie information.

In the method, the command program may include a cookie reference command program, and the controlling of the data storage unit may include according to the cookie reference command program, searching the data storage unit for at least one cookie information item; and extracting predetermined target information from the at least one cookie information item.

In the method, the command program may include a cookie deletion command program, and the controlling of the data storage unit may include: according to the cookie deletion command program, searching for at least one cookie information item, among a plurality of cookie information items stored in the data storage unit, that matches cookie information the cookie deletion command program commands to delete; and deleting the at least one cookie information item.

According to still another aspect of the present invention, there is provided an information storage medium including audio/video (AV) data and a markup document reproducing the AV data, the markup document having a command program to control a data storage unit of a content reproducing apparatus.

In the information storage medium of the present invention, the command program may include a cookie generation command program, where the cookie generation command program performs control so that the content reproducing apparatus generates cookie information including predetermined target information and stores the cookie information in the data storage unit.

In the information storage medium, the cookie generation command program performs control so that the content reproducing apparatus generates cookie information including content identification information related to the markup document and stores the cookie information in the data storage unit.

In the information storage medium, the command program may include a cookie reference command program, where the cookie reference command program performs control so that the content reproducing apparatus searches the data storage unit for cookie information with predetermined target information and extracts the predetermined target information.

In the information storage medium, the command program may include a cookie deletion command program, where the cookie deletion command program performs control so that the content reproducing apparatus searches for at least one cookie information item, among a plurality of cookie information items stored in the data storage unit, that matches cookie information the cookie deletion command program commands to delete, and deletes the at least one cookie information item.

Various aspects and/or advantages of the invention will be set forth in part in the description that follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram showing a content reproducing apparatus, according to an aspect of the present invention;

FIG. 2 is a block diagram illustrating a detailed structure of a presentation engine shown in FIG. 1;

FIG. 3 is a diagram showing a directory structure of data stored in a content storage medium according to the present invention;

FIG. 4 is a flowchart illustrating a content reproducing method according to an aspect of the present invention;

FIG. 5 is a flowchart illustrating an extracted command program shown in FIG. 4;

FIG. 6 is a flowchart illustrating another aspect of the performing of the extracted command program shown in FIG. 4;

FIG. 7 is a flowchart illustrating still another aspect of the performing of the extracted command program shown in FIG. 4; and

FIG. 8 is a flowchart illustrating another aspect of the content reproducing method according to the present invention.

### DETAILED DESCRIPTION OF THE INVENTION

Reference will now be made in detail to the aspects of the present invention, examples of which are illustrated in the accompanying drawings, wherein like reference numerals refer to like elements throughout. The aspects are described below in order to explain the present invention by referring to the figures.

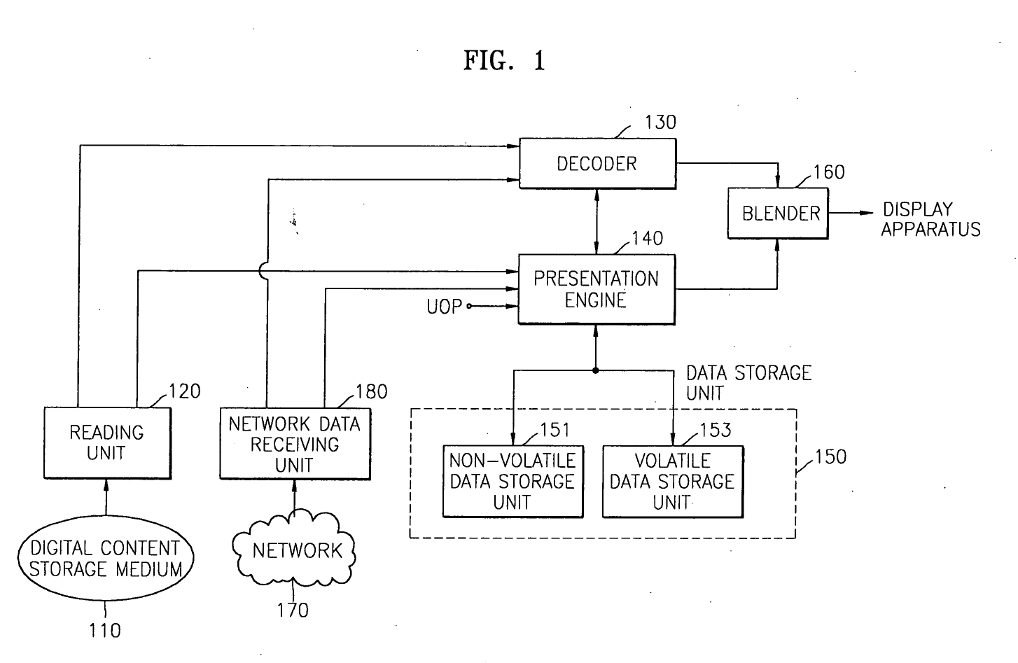

Referring to FIGS. 1 through 3, a content reproducing according to an aspect of the present invention will now be explained.

FIG. 1 is a block diagram showing a content reproducing apparatus 100 according to an aspect of the present invention. Referring to FIG. 1, the content reproducing apparatus includes a reading unit 120, a decoder 130, a presentation engine 140, a data storage unit 150, a blender 160, a network 170, and a network access unit 180. The data storage unit 150 includes a non-volatile data storage portion 151 and a volatile data storage portion 153.

A digital content storage medium 110 is a medium for storing the interactive contents, for example, an interactive DVD. The interactive DVD stores AV data, markup documents, and other types of data.

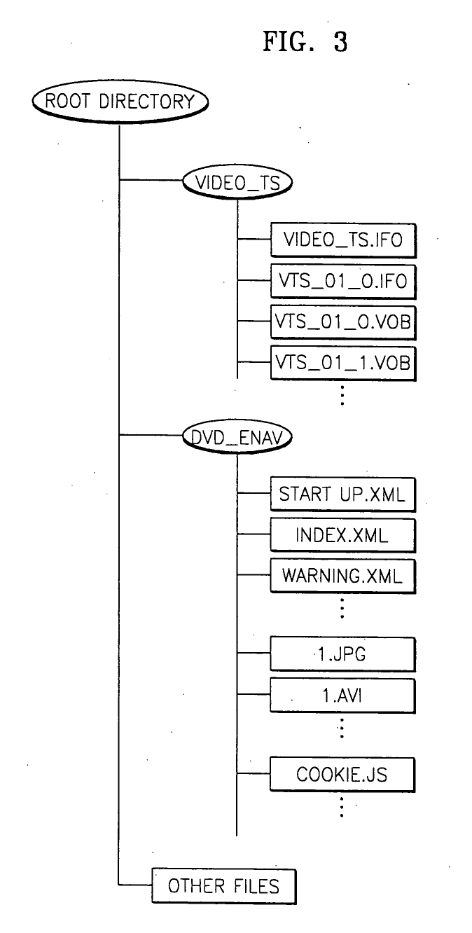

FIG. 3 is a diagram showing a directory structure of the data stored in the digital content storage medium 110, according to an aspect of the present invention. The directory structure includes a VIDEO_TS directory for storing the AV data, a DVD_ENAV directory for storing the data supporting interactive functions, such as the markup documents, and other files.

The markup document includes a command program which controls the data storage unit 150. The presentation engine 140 interprets the command program and executes commands. The command program is written in a Java script language. Also, the command program may be written in other languages, for example, a Visual Basic script language.

The command program in the markup document is written such that the command program has at least a cookie generation command program, a cookie reference program, or a cookie deletion program. The cookie generation command program commands that predetermined information on the current document be stored in a form of the cookie in the data storage unit 150. The cookie reference command program commands that the predetermined information previously stored be fetched by referring to the stored cookie. The cookie deletion command program commands that the cookie containing the predetermined information be deleted. The command program is written by the content creator when the markup document is written.

An example of the cookie command program written in a head part of the markup document that is written in DVD-HTML version 1.0, which can be defined as the markup language for interactive DVDs, will now be explained.

```
  <?xml version =“1.0”□ encoding=“UTF-8”?>
  <!DOCTYPE html PUBLIC “-//DVD//DTD XHTML DVD-HTML
  1.0//EN”
  “http://www.dvdforum.org/envideo/dtd/dvdhtml-1-0.dtd”>
  <html>
  <head>
  <title>Embodiment </title>
  <meta name=“diskid” content=“disk.1”/>
  <meta name=“contentid” content=“3AE86B20-7BE8-11D1-ABE6-
00A0C905F375”/>
  <script type=□ text/ecmascript>
  var playstate // a variable for storing the reproducing state of DVD
video embedded in the current page
  var parental_level // a variable for storing a parental level set to the
current reproducing apparatus
  playstate = InteractiveDVD.PlayState
  parental_level = InteractiveDVD.ParentalLevel
  </script>
  <script type =“text/ecmascript” src=“cookie.js”>
  // To reduce the size of a document, by externally referring to functions
setCookie( ), getCookie( ), delCookie( )
  </script>
  <script type =“text/ecmascript”>
  // To store needed information
  setCookie(“parental_level”, parental_level, “permanent”,
  “/dvd_enav”,“dvd:”)
  setCookie(“play_state”, playstate)
  // To obtain needed information
  getCookie(“user_input”,“dvd:”) // An example for obtaining a user
input value stored in the previous page
  getCookie(“form_1”) // An example for referring to the contents
stored in the first space of the previous page
  // To delete stored information
  delCookie(“form_2”,“dvd:”) // An example for deleting the contents
stored in the second space of the previous page
  // -->
  </script>
  </head>
  <body>
  ...
  </body>
  </html>
```

The command program in the above embodiment is written in an ECMA script.

In the head part of the markup document, “contentid,” which is content identification information is defined as “3AE86B20-7BE8-11D1-ABE6-00A0C905F3 75”. Also, “diskid,” which is information indicating a volume number of the disk when the digital content is formed with a plurality of disks and is defined as “disk. 1,” which indicates that the disk is a first disk of the digital content. The content identification information is information indicating a particular video title or a particular game title. The content identification information may be defined in the markup document as described above, and may be written in a predetermined area of the content storage medium 110.

The “playstate” is a system variable for storing a reproducing state, that is, reproduction, pause, stop, etc., of the DVD video embedded in a current page (markup document), and “parental_level” is a variable for storing parental_level that is set to the current reproducing apparatus. The parental_level is information indicating a system variable set to the reproducing apparatus 100 in order to prevent reproduction of a video program that is inappropriate for children or teenagers, or information indicating a permitted age to watch the digital content in the DVD video. For example, NC-17 indicates that the permitted age to watch the digital content is 17.

The variables playstate and parental_level receive property values of InteractiveDVD.PlayState and InteractiveDVD.ParentalLevel, respectively, from the decoder 130 and store the property values as respective variable values. An application program interface (API) is a set of functions for interfacing a DVD video program with a markup document, and the API can be broken down into three types, “method,” “property,” and “event.” An example of the API is an API defined in InterActual's Application Program Interface Specification. In an aspect of the present invention, the API of InterActual will be referred to as the program interface.

In an aspect of the present invention, it is shown that the three programs, the cookie generation command program, the cookie reference command program, and the cookie deletion command program are included.

First, the cookie generation command program part generates a cookie by using a “setCookie” function. Among the elements of the cookie, “parental_level” and parental_level correspond to a name and a value, respectively, of target information to be stored in the data storage unit 150, for example, information on a system variable.

The “permanent” information indicates that the generated cookie information will be stored in the non-volatile data storage portion 151 of the data storage unit 150. That is, the information is an example of attribute information which determines where generated cookie information is to be stored. If there is no “permanent” information, the generated cookie information is stored in the volatile data storage portion 151.

If the content reproducing apparatus 100 is turned off and then again turned on; or if the digital content is stored on a plurality of disks and after removing a current disk from the content reproducing apparatus 100, another disk is placed therein, information to be used again in a new markup document is stored in the form of the cookie information in the non-volatile data storage portion 151.

The cookie attribute information may be expressed by other methods other than the method using the presence of the “permanent” information. For example, date information indicating a duration of the cookie information may be used as cookie storage attribute information. That is, if the date information is for a future date when compared to a current date, the cookie information is stored in the non-volatile data storage portion 151. Accordingly, after a predetermined duration, the cookie information is deleted. In another method, when there is no duration information, the cookie information may be deleted when a viewer indicating the markup document finishes.

The cookie information stored in the data storage unit 150 may further include content identification information to identify the cookie information. Desired cookie information can be searched more accurately with reference to the content identification information incorporated into the cookie information.

In a method of incorporating content identification information into cookie information, like conventional methods, the content identification information may be stored as content_ID=“value of content_ID” in a portion of the cookie information with name=“value”. The content identification information is stored as an element of the cookie information. In order to enable the cookie information to be searched, with more accuracy, with reference to the content identification information, the content identification information may be stored as mandatory information or an attribute value. A cookie with the content identification information stored as mandatory information has a different format from conventional ones. Meanwhile, the content identification information stored as an attribute value is optional so that a cookie with the content identification information stored as an attribute value, may have substantially the same format as a conventional one.

The content identification information may be retrieved from an arbitrary region of the content storage medium 110, and/or from the head part of a markup document.

The “/dvd_enav” is information indicating a path, and is used to name the path in a domain (the reproducing apparatus) in which the stored information is effectively used. If the stored information corresponds to an effective domain, a path name of the current markup document is compared with a path attribute stored in the data storage unit 150. If the path name matches the path attribute, it is determined that the stored information is effective. Path “/samsung” may be regarded as a path matching “/samsungelectronics,” or “/samsung/index.html” which contains the same character string. Also, only the path that has exactly the same text as the path attribute may be defined as an identical path.

By “getCookie” function, the cookie reference command program searches the data storage unit 150, which stores the plurality of cookies, for a desired cookie and fetches the value of the desired target information. With the name “user input” of target information as a key value, the script interpreter 147 of the presentation engine 140 searches the data storage unit 150, which stores the plurality of cookies, for the cookies having a the domain name “dvd;” and then searches for cookies having the same path information as the path of the current markup document. Among those cookies, the script interpreter 147 searches for a cookie having a name “user input” of the target information, and fetches a value “user input” of the target information of the cookie.

As described above, when content identification information is further incorporated into the cookie information, in addition to searching for the cookies having the same domain name or the same path information, the content identification information may be utilized alone to search for a desired cookie. Alternatively, a getCookie function further including the content identification information may be defined for the same purpose.

By “delCookie” function, the cookie deletion command program searches the data storage unit 150, which stores the plurality of cookies, for the desired cookie and deletes the desired cookie. With the name “form 2” of target information as a key value, the script interpreter 147 of the presentation engine 140, searches the data storage unit 150, which stores the plurality of cookies, for cookies having the domain name “dvd;” and then searches for cookies having the same path information as the path of the current markup document. Among those cookies, the script interpreter 147 deletes cookies having the name of target information “form 2.”

As described above, when the content identification information is further incorporated into cookie information, a delCookie function may be defined to delete predetermined cookie information among the cookies with the content identification information.

Meanwhile, in an aspect of the present invention related to the program <script type=“text/ecmascript”src=“cookie.js”> described in the head part, the functions “setCookie,” “getCookie,” and “delCookie” are stored as files outside the program, that is, in the digital content storage medium 110. The functions are referred to by the presentation engine 140 when the command program is executed. A size of the markup document can be reduced with reference to the functions outside the program. It is shown in FIG. 3 that a file “cookie.js” is in the DVD_ENAV directory, which is an example of a file defining those functions. Also, the functions may be defined in the markup document.

Next, the reading unit 120 reads the data from the digital content storage medium 110, outputs the AV data to the decoder 130, and outputs the data to the presentation engine 140, including the markup document related to the interactive functions.

The AV data or the markup document and other data may be transmitted through the network 170. If a content of an online game is transmitted through the network 170, the network access unit 180 receives the content, outputs the AV data to the decoder 130, and outputs the markup document and other data to the presentation engine 140.

The decoder 130 receives and decodes the AV data. For example, the video data encoded in the MPEG method is decoded or the audio data encoded in the MPEG or AC3 method is decoded.

The presentation engine 140 receives the markup document and other data, and, according to the command program included in the markup document, controls the data storage unit 150. Also, the presentation engine 140 receives an input user operation (UOP) from the user and performs interactive functions. The UOP includes, for example, commands related to reproduction, such as play, pause, and stop that are input by the user through a remote controller, and commands related to navigation key inputs needed when the interactive digital content is reproduced. On a display apparatus, a screen in which the AV data is reproduced and is embedded in the markup document is shown through the browser to the user.

According to the control of the presentation engine 140 which interprets and performs the command program included in the markup document, the data storage unit 150 stores generated cookie information and outputs the cookie information to the presentation engine 140 or deletes the cookie information. The data storage unit 150 has the non-volatile data storage portion 151 and the volatile data storage portion 153. As described above, if the content reproducing apparatus 100 is turned off and then turned on again, or if the content is stored in the plurality of disks and the current disk is removed from the reproducing apparatus 100 and then another disk is placed therein, the information which should be used again in the markup document is stored in the form of the cookie information in the non-volatile data storage portion 151, according to the control of the presentation engine 140. Whether the generated cookie information is stored in the non-volatile data storage portion 151 or in the volatile data storage portion 152 is determined by the cookie storage attribute information in the cookie generation command program. For example, if the cookie storage attribute information is “permanent”, the generated cookie information is stored in the non-volatile data storage portion 151. Instead of using the information “permanent” to indicate the cookie storage attribute information, date information indicating a duration of the cookie information may be used for the same purpose.

The cookie information stored in the data storage unit 150 may further include the content identification information identifying the cookie information. The desired cookie information can be searched with more accuracy with reference to the content identification information incorporated into the cookie information.

The presentation engine 140 interprets and performs the cookie reference command program and searches the cookie information stored in the non-volatile data storage portion 151 or the volatile data storage portion 153 to read the predetermined target information.

The presentation engine 140 interprets and performs the cookie deletion command program and searches the non-volatile data storage portion 151 or the volatile data storage portion 153 for cookie information the cookie deletion command program commands to delete and deletes the cookie information containing the predetermined target information.

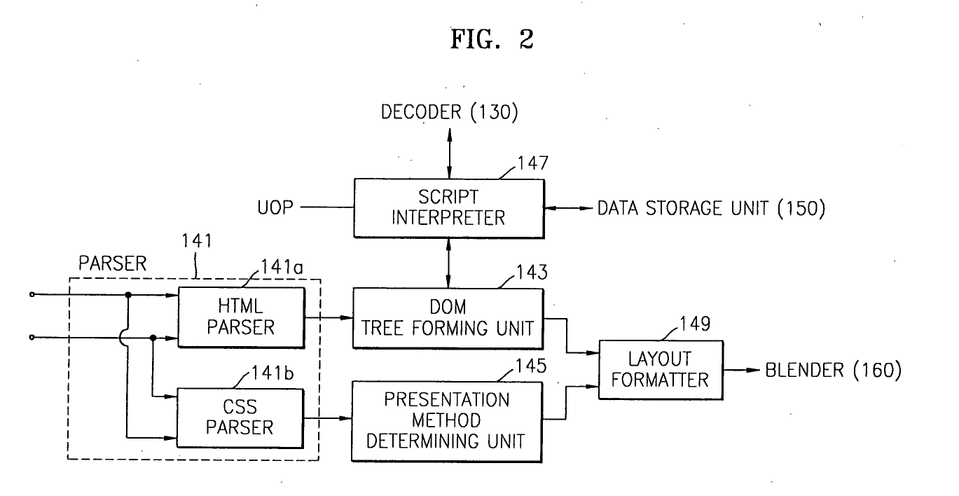

FIG. 2 is a block diagram illustrating a detailed structure of the presentation engine 140 shown in FIG. 1. The presentation engine 140 includes a parser 141, a document object model (DOM) tree forming unit 143, a presentation method determining unit 145, a script interpreter 147, and a layout formatter 149.

First, the parser 141 includes an HTML parser 141a and a cascading style sheet (CSS) parser 141b. When the HTML markup document is input, the HTML parser 141a verifies whether or not the document complies with the HTML syntax.

The CSS parser 141b verifies whether or not the markup document complies with display rules of colors and the fonts.

The DOM tree forming unit 143 makes the markup document structured. That is, the DOM tree forming unit 143 divides the markup document into a head part and a body part, and divides the head part again into a title and tag parts, and by doing so, makes the markup document a tree format such that the data is structured. Through the structuring process in the DOM tree forming unit 143, the command program is also extracted.

The presentation method determining unit 145 determines the display method including the colors and the fonts.

The script interpreter 147 receives a command program extracted from the DOM tree forming unit 143, generates a cookie, and stores the cookie in the data storage unit 150, refers to the stored cookie, or deletes the stored cookie. By doing so, the script interpreter 147 performs operations to control the data storage unit 150.

The layout formatter 149 determines a layout format for the screen according to the layout information indicated by each tag of the markup document and outputs the formats to the blender 160.

Referring to attached drawings, a content reproducing method according to an aspect of the present invention will now be explained.

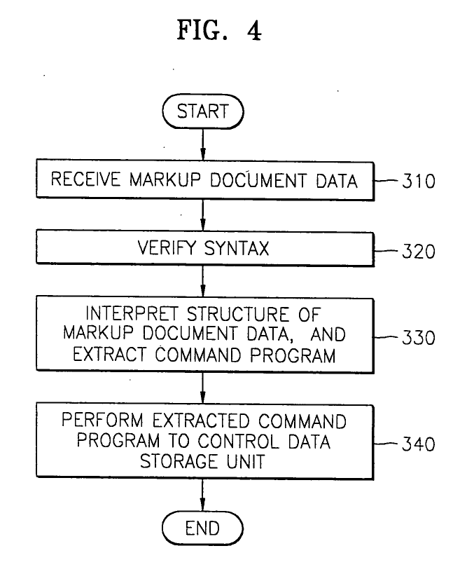

FIG. 4 is a flowchart illustrating the content reproducing method which is performed in the content reproducing apparatus according to an aspect of the present invention shown in FIG. 2.

At operation 310, the markup document stored in the digital content storage medium 110 is read by the reading unit 120 and input to the parser 141, or the markup document transmitted through the network 170 is input to the parser 141 via the network access unit 180.

At operation 320, the parser 141 verifies whether or not the markup document complies with the syntax of the markup language and with the display rules of the colors and the fonts.

At operation 330, the DOM tree forming unit 143 interprets the structure of the markup document and extracts the command program to control the data storage unit 150.

At operation 340, the script interpreter 147 receives a command program extracted from the DOM tree forming unit 143, generates the cookie, and stores the cookie in the data storage unit 150, refers to the stored cookies, or deletes the cookie to control the data storage unit 150.

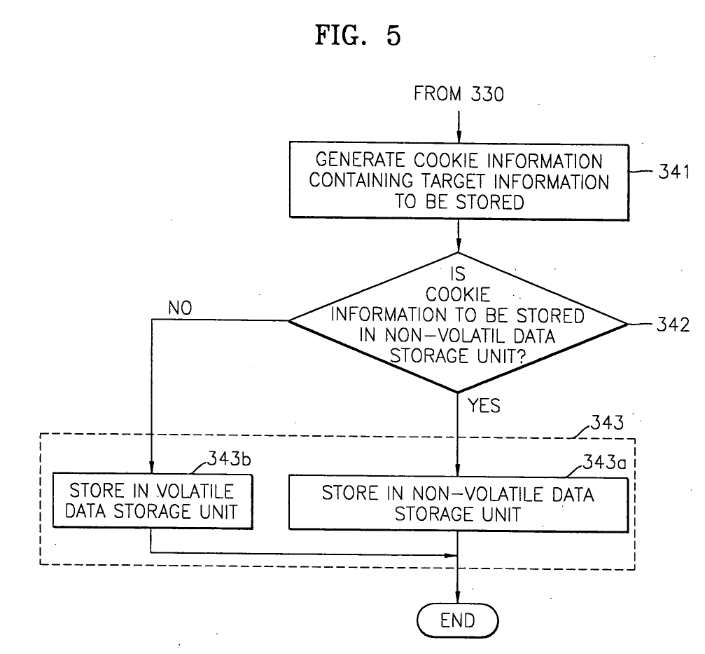

FIG. 5 is a flowchart illustrating operation 340 shown in FIG. 4, in which the command program is the cookie generation command program.

At operation 341, the script interpreter 147 generates the cookie information containing the target information to be stored. As described above, the cookie information includes information defining the effective reproducing apparatus, the information indicating the path of the markup document in which the target information is effectively used, and the target information. Also, the target information is a pair of the name which identifies the target information and the value of the target information. Also, the cookie information may be generated such that the information of the duration which defines the effective period of the cookie information is also included. The cookie information may further include the content identification information, as described above, to identify the cookie information. The desired cookie information can be searched more accurately with reference to the content identification information incorporated into the cookie information.

After operation 341, at operation 342, the script interpreter 147 determines whether or not the generated cookie information is to be stored in the non-volatile data storage portion 151. According to the cookie storage attribute information in the cookie generation command program, the script interpreter 147 determines whether to store the cookie information in the non-volatile data storage portion 151 or in the volatile data storage portion 153.

At operation 343, the script interpreter 147 stores the generated cookie information in the data storage unit 150. If the cookie storage attribute information in the cookie generation command program commands the non-volatile data storage portion 151 to store the cookie information, then at operation 343a, the cookie information is stored in the non-volatile data storage portion 151.

If the cookie storage attribute information in the cookie generation command program commands the volatile data storage portion 153 to store the cookie information, at operation 343b, the cookie information is stored in the volatile data storage portion 153.

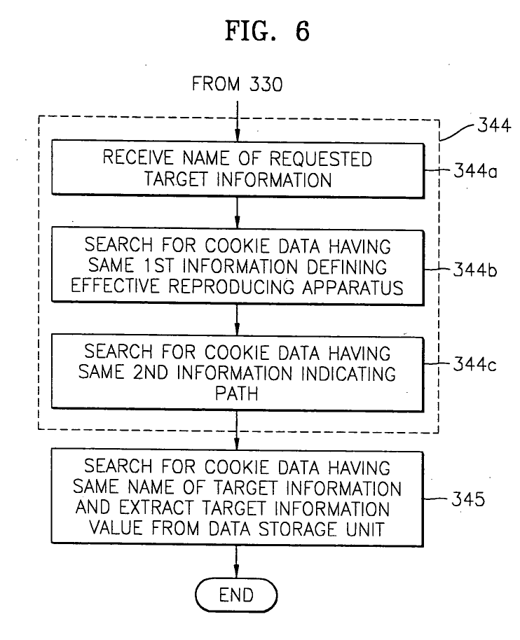

FIG. 6 is a flowchart illustrating another aspect of operation 340 shown in FIG. 4.

First, at operation 344, according to the description of the cookie reference command program, the script interpreter 147 searches the data storage unit 150, which stores the plurality of cookies, for the desired cookie information.

Operation 344 includes the following sub operations. At operation 344a, the script interpreter 147 receives the name of target information requested by the cookie reference program.

At operation 344b, the script interpreter 147 searches the data storage unit 150 storing the plurality of cookie information items for the cookie information items having the same information defining the effective reproducing apparatus as in the cookie reference command program.

Among the plurality of cookie information items having the same information defining the effective reproducing apparatus, at operation 344C, the script interpreter 147 searches for the cookie information items having the same information indicating the path of the markup document as in the command program.

Among the cookie information items having the same information defining the effective reproducing apparatus and the same information indicating the path as in the command program, at operation 345, the script interpreter 147 searches for the cookie information item having the same name of the target information as in the command program and extracts the value of the target information corresponding to the cookie information item. Also, when the cookie reference command program does not specify the name of the target information, a plurality of values of the target information from the plurality of cookie information items having the same information defining the effective reproducing apparatus and the same information indicating the path may be extracted.

Although not illustrated in the drawings, when the cookie information further includes content identification information, the cookie reference command program may be defined to fetch a value of target information among the plurality of stored cookie information items with the predetermined content identification information.

When a value of target information is retrieved through the network 170 from a remote server, the cookie information with the predetermined content identification information is transmitted to the remove server. The remote server transmits the value of the target information corresponding to the predetermined content identification information of the received cookie information and the name of the target information to the content reproducing apparatus 100, according to an aspect of the present invention.

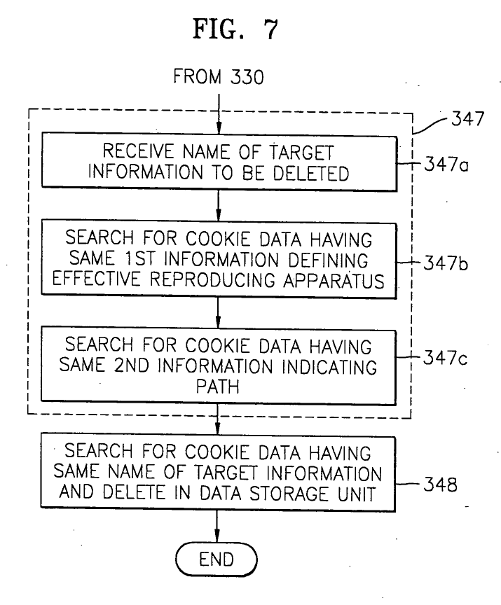

FIG. 7 is a flowchart illustrating still another aspect of operation 340 shown in FIG. 4, in which the command program is the cookie deletion command program.

At operation 347, the script interpreter 147 searches the data storage unit 150 storing the plurality of cookie information items, for the cookie information item corresponding to the cookie information to delete, which is indicated by the cookie deletion command program.

The operation 347 includes sub operations 347a, 347b, and 347c. At operation 347a, the script interpreter 147 receives the name of the target information to delete according to the cookie deletion command program. At operation 347b, the script interpreter 147 searches the data storage unit 150 storing the plurality of cookie information items, for the cookie information items having the same information defining the effective reproducing apparatus as in the command program. At operation 347c, the script interpreter 147 searches the plurality of cookie information items having the same information defining the effective reproducing apparatus for the cookie information items having the same information indicating the path of the markup document as in the command program.

At operation 348, the script interpreter 147 searches for the cookie information item having the same name of the target information as in the command program and deletes the cookie information item in the data storage unit 150.

Although not illustrated in the drawings, when the cookie information further includes the content identification information, a cookie deletion command program may be defined to delete predetermined cookie information among the plurality of stored cookie information items with the predetermined content identification information.

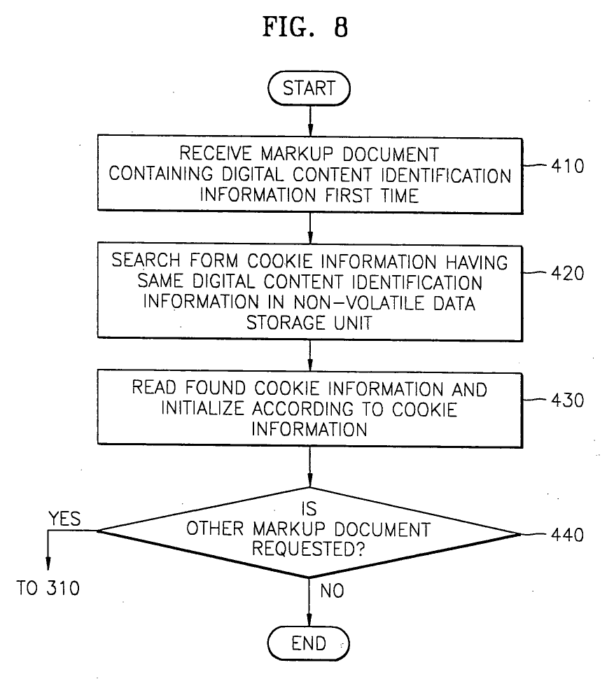

FIG. 8 is a flowchart illustrating another aspect of the content reproducing method performed in the content reproducing apparatus 100 shown in FIGS. 1 and 2, according to an aspect of the present invention.

At operation 410, the content reproducing apparatus 100 receives the markup document including the content identification information for the first time. The markup document may be stored in the digital content storage medium 110, or may be transmitted through the network 170. The markup document that is input for the first time is the markup document which is first input after the content reproducing apparatus 100 is turned on or after the new disk is placed.

At operation 420, the content reproducing apparatus 100, which receives the markup document for the first time, searches the non-volatile data storage portion 151 storing the plurality of cookie information items for a cookie information item having the same content identification information as described in the markup document. The content identification information may be retrieved from an arbitrary area of the content storage medium 110, and/or from the markup document.

At operation 430, the content reproducing apparatus 100 reads the predetermined target information from the cookie information searched through the non-volatile data storage portion 151 and initializes the content reproducing apparatus 100.

At operation 440, the content reproducing apparatus 100 determines whether or not another markup document is requested. If another markup document is requested, operation 310 shown in FIG. 4 is performed and then, operations 320 through 340 are performed. If another markup document is not requested, the process is finished.

The present invention may be embodied in a code program, which can be read by a computer, on a computer readable recording medium. The computer readable recording medium includes all types of recording apparatuses on which computer readable data is stored. The computer readable recording media includes storage media such as magnetic storage media (e.g., ROM's, floppy disks, hard disks, etc.), optically readable media (e.g., CD-ROMs, DVDs, etc.) and carrier waves (e.g., transmissions over the Internet). Also, the computer readable recording media can be stored on computer systems connected through a network and executed in a distributed mode.

As described above, in a content reproducing apparatus and method and an information storage medium therefor, according to an aspect of the present invention, the content reproducing apparatus is assumed to be a domain, and predetermined information on a current markup document is stored in a data storage unit in a predetermined domain using cookies. When a markup document is changed, needed information is read with reference to the stored cookies so that a browser does not need to be redefined. Further, transferring of information and/or sharing system parameters between markup documents are enabled without heavily loading a CPU.

Although a few aspects of the present invention have been shown and described, it would be appreciated by those skilled in the art that changes may be made in this aspects without departing from the principles and spirit of the invention, the scope of which is defined in the claims and their equivalents.

What is claimed is:

1. A content reproducing method, comprising:
receiving a markup document comprising a predetermined command program;
parsing to verify a syntax of the markup document;
extracting the command program by interpreting a structure of the markup document; and
controlling a data storage unit according to the command program.

2. The content reproducing method of claim 1, wherein the command program is written in a script language.

3. The content reproducing method of claim 1, wherein the controlling of the data storage unit comprises:
according to the command program, generating cookie information; and
storing the generated cookie information in the data storage unit.

4. The content reproducing method of claim 3, wherein in the storing of the generated cookie information, the generated cookie information is stored in one of a non-volatile data storage portion and a volatile data storage portion of the data storage unit according to a cookie storage attribute value in the command program.

5. The content reproducing method of claim 3, wherein the generation of the cookie information comprises incorporating content identification information into the cookie information.

6. The content reproducing method of claim 3, wherein the generation of the cookie information comprising fetching predetermined target information from a decoder decoding AV data.

7. The content reproducing method of claim 3, wherein in the generation of the cookie information, cookie information with predetermined target information in the markup document is generated.

8. The content reproducing method of claim 3, further comprising:
receiving data from a user before the controlling of the data storage unit, wherein in the generation of the cookie information, the cookie information with predetermined target information in the data received from the user is generated.

9. The content reproducing method of claim 1, wherein the command program comprises a cookie reference command program, and the controlling of the data storage unit comprises:
according to the cookie reference command program, searching the data storage unit for at least one cookie information item; and
extracting predetermined target information from the at least one cookie information item.

10. The content reproducing method of claim 1, wherein the command program comprises a cookie deletion command program, and the controlling of the data storage unit comprises:
according to the cookie deletion command program, searching the data storage medium for at least one cookie information item that matches the cookie information the cookie deletion command program commands to delete; and
deleting the at least one cookie information item.

11. The content reproducing method of claim 1, wherein the cookie information comprises at least first information defining a content reproducing apparatus using the cookie information, and second information indicating a path of a markup document using the target information, where the target information is a pair of a name identifying the target information and a value of the target information.

12. The content reproducing method of claim 2, wherein the cookie information comprises at least first information defining a content reproducing apparatus using the cookie information, and second information indicating a path of a markup document using the target information, where the target information is a pair of a name identifying the target information and a value of the target information.

13. The content reproducing method of claim 3, wherein the cookie information comprises at least first information defining a content reproducing apparatus using the cookie information, and second information indicating a path of a markup document using the target information, where the target information is a pair of a name identifying the target information and a value of the target information.

14. The content reproducing method of claim 4, wherein the cookie information comprises at least first information defining a content reproducing apparatus using the cookie information, and second information indicating a path of a markup document using the target information, where the target information is a pair of a name identifying the target information and a value of the target information.

15. The content reproducing method of claim 5, wherein the cookie information comprises at least first information defining a content reproducing apparatus using the cookie information, and second information indicating a path of a markup document using the target information, where the target information is a pair of a name identifying the target information and a value of the target information.

16. The content reproducing method of claim 6, wherein the cookie information comprises at least first information defining a content reproducing apparatus using the cookie information, and second information indicating a path of a markup document using the target information, where the target information is a pair of a name identifying the target information and a value of the target information.

17. The content reproducing method of claim 7, wherein the cookie information comprises at least first information defining a content reproducing apparatus using the cookie information, and second information indicating a path of a markup document using the target information, where the target information is a pair of a name identifying the target information and a value of the target information.

18. The content reproducing method of claim 8, wherein the cookie information comprises at least first information defining a content reproducing apparatus using the cookie information, and second information indicating a path of a markup document using the target information, where the target information is a pair of a name identifying the target information and a value of the target information.

19. The content reproducing method of claim 9, wherein the cookie information comprises at least first information defining a content reproducing apparatus using the cookie information, and second information indicating a path of a markup document using the target information, where the target information is a pair of a name identifying the target information and a value of the target information.

20. The content reproducing method of claim 1, wherein the cookie information comprises at least first information defining a content reproducing apparatus using the cookie information, and second information indicating a path of a markup document using the target information, where the target information is a pair of a name identifying the target information and a value of the target information.

21. The content reproducing method of claim 11, wherein the cookie information further comprises third information defining a duration of the cookie information.

22. The content reproducing method of claim 11, wherein in the storing of the generated cookie information, if the cookie information has the same first information and second information, and the same name to identify the target information as the cookie information generated according to the command program exists in the data storage unit, the cookie information in the data storage unit is overwritten with the generated cookie information.

23. The content reproducing method of claim 9, wherein in the search of the at least one cookie information item, at least one cookie information item with predetermined content identification information is searched through the data storage unit according to the cookie reference command program.

24. The content reproducing method of claim 23, wherein in the search of the at least one cookie information item, at least one cookie information item having a name to identify the target information is searched.

25. A content reproducing method for reproducing interactive digital content in an interactive digital content reproducing apparatus, comprising:
receiving a markup document containing digital content identification information;
searching, a data storage unit included in the interactive digital content reproducing apparatus, for cookie information with digital content identification information that matches digital content identification information in the received markup document; and
reading predetermined target information in the cookie information.

26. The content reproducing method of claim 25, wherein cookie information items stored in the data storage unit, among which the cookie information is searched, are generated according to a command program where the cookie information items comprise content identification information and predetermined target information, and the cookie information items are stored in one of a non-volatile data storage portion and a volatile data storage portion of the data storage unit according to a cookie storage attribute value in the command program.
